(19) United States
(12) Patent Application Publication
(10) Pub. No.: US 2005/0046635 A1
(43) Pub. Date: Mar. 3, 2005

(54) Apparatus and method for processing images and drawing sprites in priority order by alfa blending on display screen

(75) Inventor: Mitsuhiro Honme, Hamamatsu-shi (JP)

Correspondence Address: PILLSBURY WINTHROP LLP, 725 S. FIGUEROA STREET, SUITE 2800, LOS ANGELES, CA, 90017, US

(73) Assignee: YAMAHA CORPORATION, Hamamatsu-shi (JP)

(21) Appl. No.: 10/927,558

(22) Filed: Aug. 26, 2004

(30) Foreign Application Priority Data
Aug. 28, 2003 (JP) P2003-305273

(51) Int. Cl. G09G 5/39

(52) U.S. Cl. 345/531

(57) ABSTRACT

An image processing apparatus and method allow a plurality of sprites to be sequentially drawn in a prescribed display order counted from a higher priority and also allows color computation to be executed with respect to a plurality of layers on the display screen. It comprises an α coefficient buffer for storing α coefficients with respect to pixels included in image displayed on the screen, an α coefficient calculation module for storing an α coefficient, which is calculated with respect to a lower layer prior to execution of α blending, and an α blending module for performing α blending by use of drawing data, drawing-completed data, and the α coefficient stored in the α coefficient module when drawing the lower layer on the display screen.

### BACKGROUND OF THE INVENTION

1. Field of the Invention

This invention relates to image processing apparatuses and image processing methods for drawing sprites using alfa (α) blending techniques in priority orders on display screens.

This application claims priority on Japanese Patent Application No. 2003-305273, the content of which is incorporated herein by reference.

2. Description of the Related Art

Image display devices applied to video game devices and the like use so-called sprite display methods in drawing sprites on display screens. According to the known sprite display method, characters (i.e., animated image, symbols, etc.) displayed on the screen have specific attributes (called “sprite attributes”) regarding display positions thereof, wherein they are arranged in accordance with sprite attributes so as to form the overall screen image. Therefore, characters having sprite attributes regarding display positions are called “sprites”. In video games, characters are moved at a high speed in an interactive manner on the display screen, wherein the entire screen image can be rewritten by merely changing sprite attributes of characters.

Conventionally, image display devices provide so-called alfa (α) blending functions actualizing semitransparent synthesis of two or more images by using specific coefficients (called “alfa values” or “α coefficients”). This α blending function may designate the common α coefficient for use in all pixels included in an image. Alternatively, it is possible to provide each pixel with specific α coefficient information, whereby it is possible to perform semitransparent synthesis using it in each pixel, which is disclosed in Japanese Patent Application Publication No. 2002-341859, for example.

In order to actualize α blending in the conventional image processing apparatus disclosed in the aforementioned publication, it is necessary to sequentially draw sprites in a display order counted from a lower priority, This is because of the necessity of executing color computation, whereas basically, a sprite having a higher priority is written over a sprite having a lower priority.

In order to sequentially draw sprites in a display order counted from a lower priority, it is necessary to draw all the sprites in a frame buffer. Herein, the drawing performance is expressed by the number of dots that can be drawn on the display screen in each unit time. However, the conventional image processing device requires all of the sprites to be drawn in a display order counted from a lower priority. This causes a problem which impedes an improvement of the drawing performance.

### SUMMARY OF THE INVENTION

It is an object of the invention to provide an image processing apparatus and an image processing method that allow a plurality of sprites to be drawn in a display order counted from a higher priority.

It is another object of the invention to provide an image processing apparatus and an image processing method that allow execution of color computation with respect to a plurality of screen images.

In a first aspect of the invention, an image processing apparatus comprises a frame buffer for storing image data to be displayed in a bit map form, an α coefficient buffer for storing α coefficients, which are set with respect to pixels of image data so as to represent transparency information regarding each pixel, an α coefficient calculation module in which when executing α blending actualizing semitransparent synthesis on two images by use of the α coefficient, an α coefficient is calculated with respect to one of the two images having a lower priority forming a lower layer and is stored in the α coefficient buffer, and an α blending module which when the lower layer or an upper layer corresponding to one of the two images having a higher priority is subjected to drawing into the frame buffer, performs α blending by use of drawing data, drawing-completed data, and the α coefficient stored in the α coefficient buffer, and in which after a sprite corresponding to the upper layer is drawn into the frame buffer, another sprite corresponding to the lower layer is drawn into the frame buffer.

In a second aspect of the invention, an image processing apparatus comprises a frame buffer for storing image data to be displayed in a bit map form, a coefficient buffer for storing coefficient data, which are set with respect to pixels of image data and which are used in pixel computation for calculating pixel data in a composite image that is formed by combining two images together, a coefficient calculation module for calculating coefficient data used for a lower layer corresponding to one of the two images having a lower priority so as to store it in the coefficient buffer in order to perform the pixel computation, and a pixel computation module which when the lower layer or an upper layer corresponding to one of the two images having a higher priority is drawn into the frame buffer, performs the pixel computation by use of drawing data, drawing-completed data, and the coefficient data stored in the coefficient buffer and in which after a sprite corresponding to the upper layer is drawn into the frame buffer, another sprite corresponding to the lower layer is drawn into the frame buffer.

In a third aspect of the invention, an image processing method is actualized by use of an α coefficient buffer for storing α coefficients, which are set with respect to pixels of image data so as to represent transparency information red each pixel, thus temporarily storing images in a frame buffer prior to display, wherein in execution of α blending actualizing semitransparent synthesis on two images by use of the a coefficient, an α coefficient is calculated with respect to one of the two images having a lower priority forming a lower layer and is stored in the α coefficient buffer; when the lower layer or an upper layer corresponding to one of the two images having a higher priority is subjected to drawing into the frame buffer, α blending is performed by use of drawing data, drawing-completed data, and the α coefficient stored in the a coefficient buffer; after a sprite corresponding to the upper layer is drawn into the frame buffer, another sprite corresponding to the lower layer is drawn into the frame buffer.

In a fourth aspect of the invention, an image processing method is actualized by use of a coefficient buffer for storing coefficient data, which are set with respect to pixels of image data and which are used in pixel computation for calculating pixel data in a composite image that is formed by combining two images together, thus temporarily storing image data in a frame buffer prior to display, wherein in computation of the composite image, coefficient data are calculated with respect to a lower layer corresponding to one of the two images having a lower priority so as to store it in the coefficient buffer; when the lower layer or an upper layer corresponding to one of the two images having a higher priority is drawn into the frame buffer, the pixel computation is performed by use of drawing data, drawing-completed data, and the coefficient data stored in the coefficient buffer; after a sprite corresponding to the upper layer is drawn into the frame buffer, another sprite corresponding to the lower layer is drawn into the frame buffer.

According to this invention, it is possible to sequentially draw a plurality of sprites in a prescribed display order counted from a higher priority, wherein it is also possible to perform color computation with respect to a plurality of layers overlapped on the display screen. Therefore, even when all sprites cannot be subjected to drawing completely, the screen image is not deteriorated very much because a sprite having a lowest priority (or sprites having lower priorities) is merely omitted from the display.

### BRIEF DESCRIPTION OF THE DRAWINGS

These and other objects, aspects, and embodiments of the present invention will be described in more detail with reference to the following drawings, in which:

FIG. 1 is a block diagram showing the constitution of an image processing apparatus in accordance with a preferred embodiment of the invention;

FIG. 2 is a table showing calculations and expressions with regard to α blending;

FIG. 3 is a block diagram showing the constitution of an α blending circuit applied to the image processing apparatus shown in FIG. 1;

FIG. 4 is circuit diagram showing the internal configuration of an α blending module shown in FIG. 3;

FIG. 5 diagrammatically shows four sprites being overlapped on a display screen; and

FIG. 6 is a block circuit showing the circuitry for performing first color computation, which is realized in the image processing apparatus shown in FIG. 1

### DESCRIPTION OF THE PREFERRED EMBODIMENT

This invention will be described in further detail by way of examples with reference to the accompanying drawings.

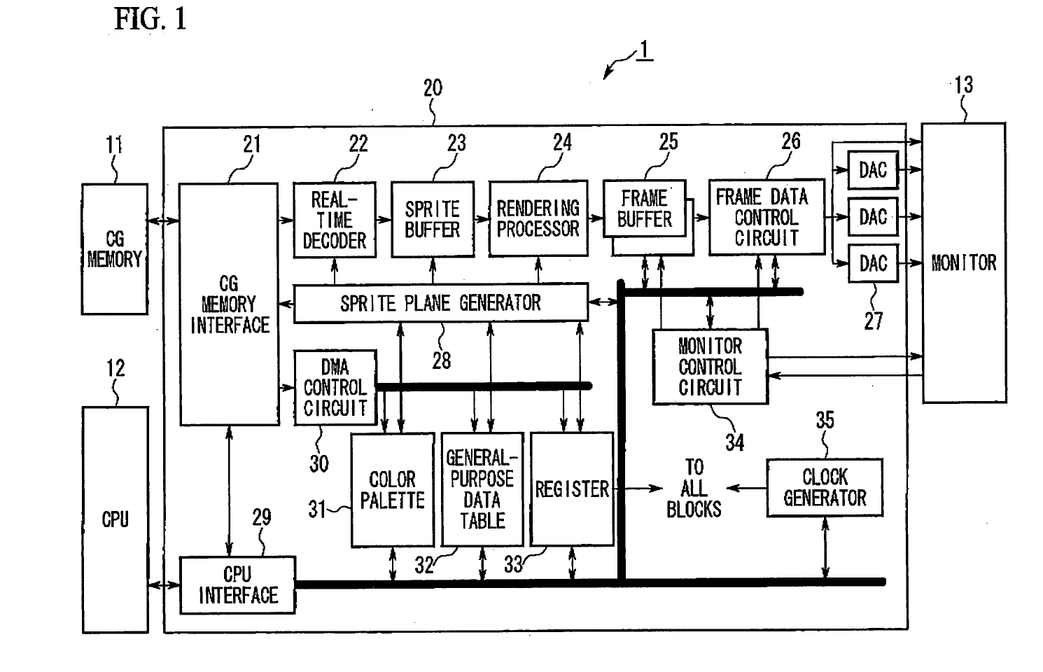

FIG. 1 is a block diagram showing the constitution of an image processing apparatus in accordance with a preferred embodiment of the invention, wherein an image processing apparatus 20 forms a constituent element of an image display apparatus 1.

The image display apparatus 1 comprises a CG (Computer Graphics) memory 11, a CPU 12, and a monitor 13 as well as the image processing apparatus 20 according to the present embodiment of the invention. The CPU 12 controls the overall operation of the image processing apparatus 20, thus displaying desired images on the screen of the monitor 13 in accordance with character data stored in the CG memory 11. The monitor 13 is constituted by a LCD (Liquid Crystal Display) Or a CRT (Cathode Ray Tube) display, for example.

The image processing apparatus 20 comprises a CG memory interface 21, a real-time decoder 22, a sprite buffer 23, a rendering processor 24, a frame buffer 25, a frame data control circuit 26, digital-to-analog converters (DACs) 27, a sprite plane generator 28, a CPU interface 29, a DMA (Direct Memory Addressing) control circuit 30, a color palette 31, a general-purpose data table 32, a register 33, a monitor control circuit 34, and a clock generator circuit 35.

Firstly, a description will be given with respect to the summary of the overall operation of the image processing apparatus 20. The image processing apparatus 20 operates in accordance with instructions from the CPU 12, i.e., upon writing of sprite attribute data into a sprite attribute table in the general-purpose data table 32. That is, in one frame period, the image processing apparatus 20 sequentially reads sprite attribute data from the sprite attribute table in the general-purpose data table 32, wherein based on the read sprite attribute data, sprites are created using character data stored in the CG memory 11 and are drawn into the frame buffer 25. For the sake of convenience, the present specification omits details of reading operations for reading sprite attribute data in the image processing apparatus 20, whereas sprites are drawn into the frame buffer 25 in a display order counted from a higher priority. For this reason, the present embodiment has special technical features in drawing sprites using α blending processing, which may differ from the conventionally used oα blending. As a result, image data drawn into the frame buffer 25 in a certain frame are output to the monitor 13 in the next flame.

Next, details of the image processing apparatus 20 will be described.

The CG memory interface 21 controls operations for reading character data from the CG memory 11. The real-time decoder 22 decodes the ‘compressed’ character data that are read from the CG memory 11 by way of the CG memory interface 21, thus converting them into ROB data (i.e., data of three primary colors, red, green, and blue, to be displayed). The sprite buffer 23 forms a temporary buffer for one or plural character data, wherein the character data are stored in the bit map form.

The rendering processor 24 performs magnification, reduction, deformation, and color computation on sprites. The frame buffer 25 stores screen image data (or frame data) each constituted by a plurality of sprites. The frame data are created by drawing sprites on the frame buffer 25. The frame buffer 25 has a double buffer configuration, for example, wherein it can draw image data of the next frame during an operation for reading frame data in synchronization with display scanning.

The frame data control circuit 26 reads frame data from the frame buffer 25 at the scanning timing of the monitor 13, which is controlled by the monitor control circuit 34, wherein the frame data are subjected to four-times magnification filtering processing or mosaic processing, thus producing dot data, which are then sent to the monitor 13. The color palette 31 is constituted by a conversion table that converts color codes into RGB data Therefore, in a palette mode, each of dots forming character data is stored in the form of a color code, whereby it is possible to perform data compression with ease compared with a normal mode (i.e., an RGB mode). The D/A converters 27 convert digital signals output from the frame data control circuit 26 into analog signals, which are then output to the monitor 13.

The sprite plane generator 28 controls operations of the real-time decoder 22, the sprite buffer 23, and the rendering processor 24 respectively. The CPU interface 29 controls accesses to the general-purpose data table 32, the color palette 31, the register 33, and the CG memory 11 respectively. The DMA control circuit 30 performs local DMA functions independently of accessing via the CPU bus, wherein it controls transferring of data to tables and registers in the image processing apparatus 20 from the CG memory 11 and the general-purpose table 32.

The general-purpose data table 32 is a storage circuit whose content can be rewritten and which is incorporated in the image processing apparatus 20. The general-purpose data table 32 stores a sprite attribute table, a four-summit deformation table, and a sprite line table, for example. The register 33 is designed to set control data for controlling the sprite display. The monitor control circuit 34 generates scanning timings in the monitor 13 based on the setting of the register 33. The clock generator 35 generates clock signals for defining internal operations in the image processing apparatus 20.

Next, the overall operation of the image processing apparatus 20 will be described.

First, the CPU 12 sets control data to the register 33 and the general-purpose data table 32 incorporated in the image processing apparatus 20, thus controlling images (or frames) displayed on the screen of the monitor 13. The control data are configured by sprite attribute data and the like for displaying sprites. Each image (or each frame) displayed on the screen of the monitor 13 is constituted by a plurality of sprites, which are combined together. Herein, display attributes making representation as to which position in the fame a sprite is to be displayed in desired manner are set into the sprite attribute table, which is formed by mapping in the general-purpose data table 32.

The sprite plane generator 28 of the image processing apparatus 20 sequentially reads sprite attribute data written in the sprite attribute table in a prescribed order with regard to each frame, wherein character data are read from the CG memory 11 in accordance with sprite display attributes set to the sprite attribute table. The character data are normally compressed and are stored in the CG memory 11 in advance, whereas they can be stored in the CG memory 11 without compression. The character data read from the CG memory 11 are subjected to real-time decoding and are converted into ROB data, which are then temporarily stored in the sprite buffer 23.

Sprites stored in the sprite buffer 23 are subjected to processing such as magnification, reduction, inversion, deformation, and color computation in the rendering processor 24 in accordance with sprite attribute data. Then, they are displayed at sprite display positions in the frame buffer 25 in accordance with sprite attribute data.

The aforementioned processing is performed a certain number of times, which correspond to the number of sprites being displayed on the screen of the monitor 13, wherein the processed sprites form image data in the fame buffer 25.

The frame buffer 25 has a double-buffer configuration, by which during a period of time in which a screen image is being formed using sprites, it is possible to control the monitor 13 to display the content of the image data, which have been already formed in the frame buffer 25. The image data are read from the frame buffer 25 in accordance with the scanning timings of the monitor 13, which are controlled by the monitor control circuit 34, and are then subjected to four-times magnification filtering processing or mosaic processing, thus producing dot data, which are supplied to the monitor 13. When the monitor 13 inputs analog signals, the image data read from the frame buffer 25 are supplied to the monitor 13 by way of the D/A converters 27. When the monitor 13 inputs digital signals, the image data read from the frame buffer 25 are directly supplied to the monitor 13.

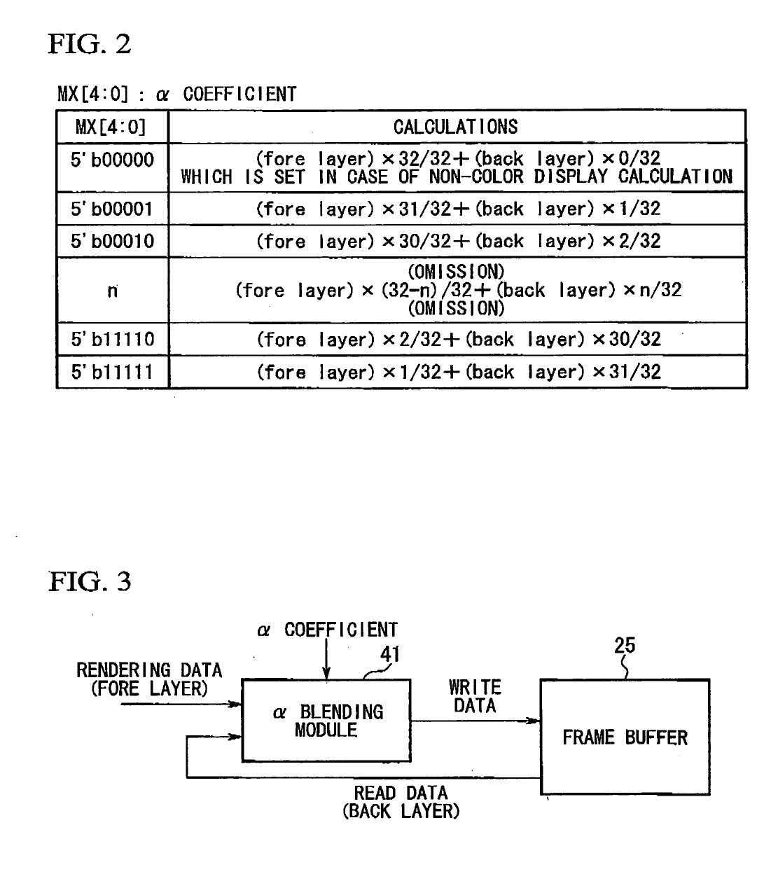

Next, α blending executed in the rendering processor 24 of the image processing apparatus 20 will be described in detail with reference to FIGS. 2 to 4, which shows the conventionally known α blending technique. The image processing apparatus 20 of the present embodiment has a capability of actualizing the conventional α blending technique as shown in FIGS. 2 to 4, wherein it is improved compared with the conventional image processing apparatus and has an ability of drawing sprites in a display order counted from a higher priority.

Incidentally, rendering data are handled as color data of a fore layer, and read data are handled as color data of a back layer, wherein such assignment of color data have been used in the conventional image processing. In contrast, the image processing of the present embodiment is designed such that rendering data are handled as color data of a back layer, and read data are handled as color data of a fore layer.

Next, the α blending will be described. FIG. 2 shows calculations and expressions with regard to α coefficients, which are set to the sprite attribute table subjected to mapping in the general-purpose data table 32. The α blending contributes to semitransparent synthesis processing using α coefficients with regard to a plurality of images.

Specifically, when a sprite is drawn into the frame buffer 25, calculations using oα coefficients shown in FIG. 2 are performed between drawing data (namely, color data of a fore layer), which are presently drawn into the fame buffer 25, and already-drawn data (namely, color data of a back layer), which have been already drawn in the frame buffer 25. Hence, α blending indicates drawing functions regarding calculation results. For example, when an α coefficient is “00000”, the first calculation within plural calculations shown in FIG. 2 is used so as to perform drawing with regard to the result thereof.

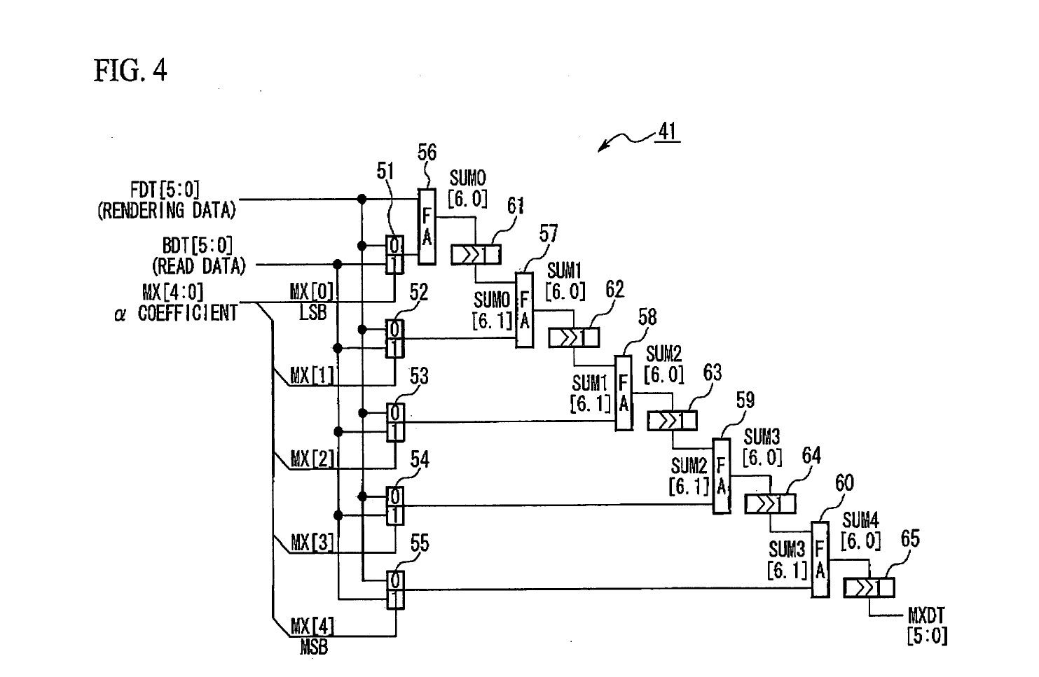

Next, a description will be given with respect to the circuitry for performing a blending with reference to FIGS. 3 and 4. FIG. 3 is a block diagram showing the constitution of an α blending circuit, which is included in the rendering processor 24 of the image processing apparatus 20 shown in FIG. 1. The α blending circuit of FIG. 3 comprises α blending module 41 in addition to the aforementioned frame buffer 25, wherein the α blending module 41 is constituted as a part of the rendering processor 24.

First, the α blending module 41 reads already-drawn data (i.e., color data of a back layer, which have been already drawn at a prescribed drawing position in the frame buffer 25 and which will be referred to as “read data”) from the frame buffer 25. Then, the α blending module 41 performs α blending using an α coefficient between the drawing data (i.e., color data of a fore layer, which are presently drawn into the frame buffer 25 and which will be referred as “rendering data”) and the read data, which are read from the frame buffer 25. Thereafter, the α blending module 41 writes the α-blending-implemented data into the frame buffer 25.

As an example of the α blending, the α blending module 41 performs calculation in accordance with the following equation.

$$\frac{32 - α}{32} \times ( rendering \cdot data ) + \frac{α}{32} \times ( read \cdot data ) \qquad ( 1 )$$

FIG. 4 is a circuit diagram showing the detailed constitution of the α blending module 41, which is designed to perform the aforementioned calculation in accordance with the equation (1). Specifically, the α blending module 41 comprises selectors 51, 52, 53, 54, and 55, full adders 56, 57, 58, 59, and 60, and shifters 61, 62, 63, 64, and 65. Each of the selectors 51 to 55 selectively outputs either the rendering data or the read data upon designation using an α coefficient.

Specifically, the selector 51 selectively outputs one of the rendering data and the read data, which is designated by the lowermost bit of the α coefficient. That is, the rendering data is selected when the lowermost bit of the α coefficient is set to ‘0’, while the read data is selected when the lowermost bit of the α coefficient is set to ‘1’. Similarly, the other selectors 52, 53, 54, and 55 select one of the rendering data and read data in accordance with the first, second, third, and fourth bits of the α coefficient respectively.

The full adders 56 adds the rendering data and the output of the selector 51, thus outputting 7-bit data. The shifter 61 outputs high-order six bits within the 7-bit output of the full adder 56. Similarly, the full adder 57 adds the output of the shifter 61 and the output of the selector 52; the full adder 58 adds the output of the shifter 62 and the output of the selector 53; the fill adder 59 adds the output of the shifter 63 and the output of the selector 54; and the full adder 60 adds the output of the shifter 64 and the output of the selector 55. The shifter 65 outputs high-order six bits within the 7-bit output of the full adder 60.

In the above, the output of the shifter 65 shows the output of the α blending module 41, ire., the result of the calculation regarding the aforementioned equation (1).

For example, when an α coefficient of “00000” is given, the α blending module 41 directly outputs the color data corresponding to the rendering data. When an α coefficient of “00001” is given, the α blending module 41 produces the following output:
(rendering data)×31/32+(read data)×1/32

As the α coefficient becomes large, α blending module 41 produces a weighted output in which the rendering data are less weighted, and the read data are greatly weighted.

When an α coefficient of “11111” is given, the α blending module 41 produces the following output:
(rendering data)×1/32+(read data)×31/32

As described above, the output of the α blending module 41 is defined such that the rendering data and the color data are each subjected to weighting using the α coefficient, wherein they are subjected to color synthesis, the result of which is output as color data.

The image processing apparatus 20 of the present embodiment is capable of actualizing a variety of color computations, which will be described below.

1. First Color Computation

Next, a description will be given with respect to first color computation (or first color image processing) executed in the image processing apparatus 20 in accordance with the present embodiment; that is, a description will be given with respect to color computation (or color image processing) in which sprites are sequentially drawn in a prescribed display order counted from a higher priority.

Incidentally, the display order designates the order for sequentially writing a plurality of sprites (i.e., image elements), which are displayed while being overlapped each other, in a prescribed priority order.

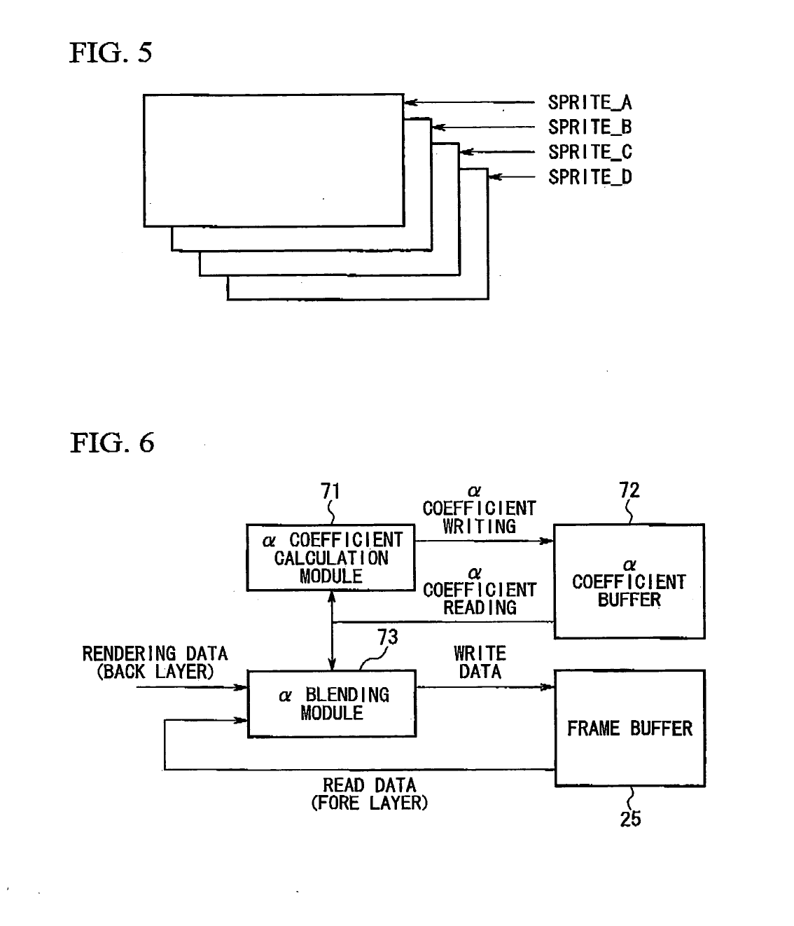

FIG. 5 diagrammatically shows four sprites overlapping each other on the display screen, by which first color computation will be described with regard to the situation where four sprites overlap each other. Herein, Sprite A is given a highest priority in the display order; Sprite B is the second place in priority; Sprite C is the third place in priority; and Sprite D is the fourth place in priority.

An example of a circuit configuration actualizing the first color computation will be described with reference to FIG. 6, which shows the circuitry for performing color image processing to sequentially draw sprites in a prescribed display order counted from a highest priority, that is, which is a block diagram showing the circuitry for executing the first color computation.

The first color computation circuit of FIG. 6 comprises an α coefficient calculation module 71, an α coefficient buffer 72, and an α blending module 73, as well as the frame buffer 25, wherein it is realized by constituent elements included in the image processing apparatus 20 shown in FIG. 1. The frame buffer 25 stores image data (or frame data) constituted by a plurality of character data.

The α coefficient calculation module 71 calculates an α coefficient with respect to the lower layer when executing α blending, so that the calculated α coefficient is stored in the α coefficient buffer 72. The α coefficient buffer 72 is designed to store α coefficients in correspondence with pixels of images on the display screen. The α blending module 73 performs α blending based on drawing data, drawing-completed data, and α coefficients stored in the α coefficient buffer 72 when drawing the lower layer. Herein, all of the α coefficient calculation module 71, α coefficient buffer 72, and α blending module 73 can be designed as constituent elements of the rendering processor 24 shown in FIG. 1. Alternatively, the α coefficient buffer 72 can be subjected to mapping in the general-purpose data table 32.

The α coefficient designates a certain value defining a mixing ratio (e.g., a weighted addition ratio or a degree of semi-transparency) established between a certain sprite and another sprite, which are overlapping each other and are subjected to semitransparent synthesis on the display screen. Herein, a single α coefficient can be commonly set to all of the dots constituting each sprite. Alternatively, α coefficients can be independently set to respective dots constituting each sprite. Incidentally, the present embodiment uses image elements embracing meanings of sprites, and dots constituting each sprite, for example.

With reference to FIG. 6, the rendering data includes ROB dot data and α coefficient, wherein the α coefficient is used in the α blending module 73 and the α coefficient calculation module 71 respectively.

Next, a description will be given with respect to the first color computation regarding four sprites overlapping each other as shown in FIG. 5.

Herein, ‘Da’ designates RGB data of Sprite A; ‘Db’ designates RGB data of Sprite B; ‘Dc’ designates ROB data of Sprite C; and ‘Dd’ designates ROB data of Sprite D. In addition, ‘αa’ designates an α coefficient for Sprite A; ‘αb’ designates an α coefficient for Sprite B; and ‘αc’ designates an ac coefficient for Sprite C. Incidentally, Sprite D is the lowest-priority sprite on which no α blending is performed.

When four sprites (i.e., Sprite A to Sprite D) overlap each other on the display screen as shown in FIG. 5, the color computation circuit performs the first color computation as follows:

$$\frac{32 - α a}{32} \times Da + \frac{α a}{32} \times [ \frac{32 - α b}{32} \times Db + \frac{α b}{32} \times ( \frac{32 - α c}{32} \times Dc + \frac{α c}{32} \times Dd ) ] \qquad ( 2 )$$

The aforementioned equation (2) can be expanded as follows:

$$\frac{32 - α a}{32} \times Da + \frac{α a}{32} \times \frac{32 - α b}{32} \times Db + \frac{α a}{32} \times \frac{α b}{32} \times \frac{32 - α c}{32} \times Dc + \frac{α a}{32} \times \frac{α b}{32} \times \frac{α b}{32} \times Dd \qquad ( 3 )$$

Next, a detailed description will be given with respect to the first color computation executed in the color computation circuit of FIG. 6.

First, the α blending module 73 draws Sprite A into the frame buffer 25. According to the first color computation, sprites are sequentially drawn into the frame buffer 25 in a prescribed display order counted from a higher priority. Since color computation is made valid with respect to Sprite A, the α blending module 73 performs computation between Sprite A and the α coefficient, so that the computation result is written into the frame buffer 25. That is, data FDa is calculated in accordance with the following equation and is written into the frame buffer 25.

$$FDa = \frac{32 - α a}{32} \times Da \qquad ( 4 )$$

At the same time, the α coefficient calculation module 71 writes an a coefficient (i.e., αa) for Sprite A into the α coefficient buffer 72.

Next, Sprite B is subjected to drawing. Since color computation is made valid with respect to Sprite B, the α coefficient calculation module 71 and the α blending module 73 performs calculations in accordance with equations (5) and (6) by use of Sprite B, α coefficient of Sprite B, and data FDa written in the frame buffer 25. Then, the calculation results are written into the flame buffer 25 and the α coefficient buffer 72. The following equation (5) shows calculation performed in the α blending module 73, whereby the calculation result FDab is written into the frame buffer 25.

$$FDab = FDa + \frac{α a}{32} \times \frac{32 - α b}{32} \times Db \qquad ( 5 )$$

The following equation (6) shows calculation performed in the α coefficient calculation module 71, wherein the calculation result (i.e., α coefficient) is written into the α coefficient buffer 72.
α coefficient=αa×αb (6)

Next, Sprite C is subjected to drawing. Since color computation is valid with respect to Sprite C, the α coefficient calculation module 71 and the α blending module 73 performs calculations in accordance with equations (7) and (8) by use of Sprite C, α coefficient of Sprite C, data FDab written in the frame buffer 25, and data (i.e., α coefficient=αa×αb) written in the α coefficient buffer 72. Then, the calculation results are written into the frame buffer 25 and the α coefficient buffer 72. The following equation (7) shows calculation performed in the α blending module 73, wherein the calculation result FDabc is written into the frame buffer 25.

$$FDabc = FDab + \frac{α a}{32} \times \frac{α b}{32} \times \frac{32 - α c}{32} \times Dc \qquad ( 7 )$$

The following equation (8) shows calculation performed in the α coefficient calculation module 71, wherein the calculation result (i.e., α coefficient) is written into the α coefficient buffer 72.
α coefficient=αa×αb×αc (8)

Last, Sprite D is subjected to drawing. Since color computation is invalid with respect to Sprite D, performs calculation in accordance with equation (9) by use of Sprite D, data FDabc written in the frame buffer 25, and data (i.e., α coefficient=α×αb×c) written in the α coefficient buffer 72. Then, the calculation result is written into the frame buffer 25. The following equation (9) shows calculation performed in the α blending module 73, wherein the calculation result (i.e., data FDabcd) is written into the frame buffer 25.

$$FDabcd = FDabc + \frac{α a}{32} \times \frac{α b}{32} \times \frac{α c}{32} \times Dd \qquad ( 9 )$$

In addition, the α coefficient calculation module 71 writes data representing zero into the α coefficient buffer 72.

As described above, the first color computation can actualize sequential drawing of sprites in a prescribed display order counted from a higher priority with respect to the frame buffer 25, and it also actualize color computation (i.e., α blending). In addition, when drawing-completed flags are set with respect to addresses of the buffer so as to inhibit re-writing of data into drawing-completed areas, it becomes unnecessary to perform writing operation on the frame memory with respect to the drawing-completed area if color computation is not performed, it is possible to further improve the drawing performance by use of the first color computation compared with the conventional technology.

2 Second Color Computation

The aforementioned first color computation is actualized in the present embodiment of the invention. For comparison with the first color computation, second color computation that can be realized in the conventional technology will be described below.

The second color computation is directed to the conventionally-used color computation in which a plurality of sprites are sequentially drawn in a display order counted from a lower priority. The image processing apparatus 20 of the present embodiment is capable of actualizing the second color computation in which a plurality of sprites are sequentially drawn into the frame buffer 25 in a display order counted from a lower priority. Of course, it is possible to further improve the drawing performance in the first color computation compared with the second color computation.

In the following description regarding the second color computation, ‘Da’ designates RGB data for Sprite A; ‘Db’ designates RGB data for Sprite B; ‘Dc’ designates ROB data for Sprite C; and ‘Dd’ designates RGB data for Sprite D. In addition, ‘αa’ designates an α coefficient for Sprite A; ‘αb’ designates an α coefficient for Sprite B; and ‘αc’ designates an α coefficient for Sprite C. Incidentally, Sprite D is the lowest-order sprite for which no α blending is performed.

First, Sprite D is subjected to drawing into the frame buffer 25, wherein the second color computation is subjected to drawing in a display order counted from a lower priority with respect to the frame buffer 25.

Next, Sprite C is subjected to drawing. Since color computation is valid in Sprite C, the result of the color computation performed on Sprite D and Sprite C is written into the frame buffer 25. Herein, a value Dcd is calculated in accordance with equation (10) and is written into the frame buffer 25.

$$Dcd = \frac{32 - α c}{32} \times Dc + \frac{α c}{32} \times Dd \qquad ( 10 )$$

Next, Sprite B is subjected to drawing. Since color computation is valid in Sprite B, the result of the color computation performed on the value Dcd, which is presently drawn into the frame buffer 25, and Sprite B is written into the frame buffer 25. That is, a value Dbcd is calculated in accordance with equation (11) and is written into the frame buffer 25.

$$Dbcd = \frac{32 - α b}{32} \times Db + \frac{α b}{32} \times Dcd \qquad ( 11 )$$

Lastly, Sprite A having a highest priority is subjected to drawing. Since color computation is valid in Sprite A, the result of the color computation performed on the value Dbcd, which is presently drawn into the frame buffer 25, and Sprite A is written into the frame buffer 25. That is, a value Dabed is calculated in accordance with equation (12) and is written into the frame buffer 25.

$$Dabcd = \frac{32 - α a}{32} \times Da + \frac{α a}{32} \times Dbcd \qquad ( 12 )$$

As described above, the first color computation in which a plurality of sprites are sequentially drawn in a display order counted from a lower priority can actualize color computation with respect to a plurality of layers on the display screen.

In the second color computation in which a plurality of sprites are sequentially drawn in a display order counted from a lower priority, it is necessary to draw all sprites into the frame buffer 25. For this reason, it has a disadvantage in which the drawing performance cannot be improved very much. In addition, when all sprites cannot be completely drawn within a prescribed time period, the sprite having the highest priority may be sacrificed and is not drawn in the frame buffer 25.

In contrast, the present embodiment uses the first color computation in which a plurality of sprites are sequentially drawn in a display order counted from a higher priority, wherein when color computation is not required, it is no longer necessary to draw drawing-completed dots; this produces an advantage in which the drawing performance can be improved. In addition, even when the conventional technology is modified to actualize the first color computation in which plural sprites are drawn in a display order counted from a higher priority, it is very difficult to actualize color computation with respect to a plurality of layers on the display screen.

That is, the image processing apparatus 20 of the present embodiment uses the first color computation by which a plurality of sprites can be sequentially drawn in a display order counted from a higher priority, whereby it is possible to execute color computation with respect to a plurality of layers on the display screen. Therefore, it is possible to noticeably improve the drawing performance in the present embodiment compared with the conventional image processing apparatus that can actualize the second color computation only.

As described heretofore, the present embodiment is described in detail in conjunction with the accompanied drawings, wherein this invention is not necessarily limited to the present embodiment; hence, it is possible to provide modifications and design changes without departing from the essential matters of this invention.

That is, the present embodiment is designed to perform color computation (i.e., α blending) in the image processing apparatus 20, whereas this invention is not necessarily limited to the present embodiment. For example, the image processing apparatus 20 can be modified to perform pixel computation, instead of the color computation (or in addition to the color computation). That is, the image processing apparatus 20 can be redesigned such that a plurality of sprites are sequentially drawn in a display order counted from a higher priority, and pixel computation can be also performed with respect to a plurality of layers on the display screen, wherein the pixel computation is related to multiplication and addition with respect to pixels.

In addition, all constituent elements of the image processing apparatus 20 of the present embodiment are basically realized by the hardware. Of course, this invention is not necessarily limited to the present embodiment; that is, a part of the constituent elements of the image processing apparatus 20 can be realized by the software.

As this invention may be embodied in several forms without departing from the spirit or essential characteristics thereof, the present embodiment is therefore illustrative and not restrictive, since the scope of the invention is defined by the appended claims rather than by the description preceding them, and all changes that fall within metes and bounds of the claims, or equivalents of such metes and bounds are therefore intended to be embraced by the claims.

1. An image processing apparatus comprising:
a buffer memory;
an image drawing module for writing first image data representing a first constituent element of an image into the buffer memory by use of first coefficient data;
a coefficient memory; and
a coefficient calculation module for writing the first coefficient data into the coefficient memory,
wherein second image data representing a second constituent element of the image whose priority is lower than that of the first constituent element of image are written into the buffer memory by use of the first coefficient data and second coefficient data that is applied to the second constituent element of the image, and
wherein third coefficient data are calculated based on the first coefficient data and the second coefficient data, so that the calculated third coefficient data are written into the coefficient memory.

2. An image processing apparatus according to claim 1, wherein the third coefficient data stored in the coefficient memory is used for writing third image data representing a third constituent element of the image whose priority is lower than that of the second constituent element of the image into the buffer memory.

3. An image processing apparatus according to claim 1, which is connected with a display that displays the constituent elements of the image on a screen based on the image data stored in the buffer memory.

4. An image processing apparatus according to claim 3, wherein the image drawing module writes the second image data into the buffer memory, so that the first image data and the second image data are combined together, whereby the first constituent element of the image and the second constituent element of the image are subjected to semitransparent synthesis and are displayed on the screen of the display.

5. An image processing apparatus according to claim 1, wherein the first coefficient data define a mixing ratio between the first constituent element of the image and another constituent element of the image, and the second coefficient data define a mixing ratio between the second constituent element of the image and the other constituent element of the image.

6. An image processing apparatus comprising:
a coefficient memory for storing first coefficient data;
a buffer memory for storing first image data representing a first constituent element of an image;
an image drawing module for writing second image data representing a second constituent element of the image whose priority is lower than that of the first constituent element of the image into the buffer memory by use of second coefficient data, which are applied to the second constituent element of the image, and the first 14 coefficient data stored in the coefficient memory; and
a coefficient calculation module for calculating third coefficient data based on the first coefficient data and the second coefficient data, thus writing the calculated third coefficient data into the coefficient memory.

7. An image processing apparatus according to claim 6, wherein the third coefficient data stored in the coefficient memory are used for writing the third image data representing a third constituent element of the image whose priority is lower than that of the second constituent element into the buffer memory by the image drawing module.

8. An image processing apparatus according to claim 6, which is connected with a display that displays the constituent element of image on a screen based on the image data stored in the buffer memory.

9. An image processing apparatus according to claim 8, wherein the image drawing module writes the second image data into the buffer memory, so that the first image data and the second image data are combined together, whereby the first constituent element of the image and the second constituent element of the image are subjected to semitransparent synthesis and are displayed on the screen of the display.

10. An image processing apparatus according to claim 6, wherein the first coefficient data define a mixing ratio between the first constituent element of image and another constituent element of the image, and the second coefficient data define a mixing ratio between the second constituent element of the image and the other constituent element of the image.

11. An image processing apparatus comprising:
a buffer memory for storing second image data representing a second constituent element of an image, which is written by use of first coefficient data and second coefficient data, wherein the second coefficient data is applied to the second image data;
a coefficient memory;
a coefficient calculation module for calculating third coefficient data based on the first coefficient data and the second coefficient data, thus writing the calculated third coefficient data into the coefficient memory; and
an image drawing module for writing third image data representing a third constituent element of the image whose priority is lower than that of the second constituent element of the image into the buffer memory by use of the third coefficient data stored in the coefficient memory.

12. An image processing apparatus according to claim 1, which is connected with a display that displays the constituent elements of the image on a screen based on the image data stored in the buffer memory.

13. An image processing apparatus according to claim 12, wherein the image drawing module writes the third image data into the buffer memory, so that the first image data and the second image data are combined together, whereby the second constituent element of the image and the third constituent element of the image are subjected to semitransparent synthesis and are displayed on the screen of the display.

14. An image processing apparatus according to claim 11, wherein the second coefficient data define a mixing ratio between the second constituent element of the image and another constituent element of the image, and the third coefficient data define a mixing ratio between the third constituent element of the image and the other constituent element of the image.

15. A computer-readable medium storing a program for executing an image processing method comprising the steps of:
writing first image data representing a first constituent element of an image into a buffer memory by use of first coefficient data;
writing the first coefficient data into a coefficient memory;
writing second image data representing a second constituent element of the image whose priority is lower than that of the first constituent element of the image into the buffer memory by use of the first coefficient data and second coefficient data that is applied to the second constituent element of image;
calculating third coefficient data based on the first coefficient data and the second coefficient data; and
writing the calculated third coefficient data into the coefficient memory.

16. A computer-readable medium storing a program for executing an image processing method comprising the steps of:
storing first coefficient data in a coefficient memory;
storing first image data representing a first constituent element of an image in a buffer memory;
writing second image data representing a second constituent element of the image whose priority is lower than that of the first constituent element of the image into the buffer memory by use of second coefficient data which are applied to the second constituent element of the image, and the first coefficient data stored in the coefficient memory; and
calculating third coefficient data based on the first coefficient data and the second coefficient data, thus writing the calculated third coefficient data into the coefficient memory.

17. A computer-readable medium storing a program for executing an image processing method comprising the steps of:
storing second image data representing a second constituent element of an image, which is written by use of first coefficient data and second coefficient data, in a buffer memory, wherein the second coefficient data is applied to the second image data;
calculating third coefficient data based on the first coefficient data and the second coefficient data, thus writing the calculated third coefficient data into a coefficient memory; and
writing third image data representing a third constituent element of the image whose priority is lower than that of the second constituent element of the image into the buffer memory by use of the third coefficient data stored in the coefficient memory.
